(19) United States
(12) Patent Application Publication
(10) Pub. No.: US 2026/0323371 A1
(43) Pub. Date: Oct. 15, 2026

(54) METHODS, ARCHITECTURES, APPARATUSES AND SYSTEMS FOR DETERMINING A PACKET DELAY BUDGET SPLIT FOR WTRU-TO-WTRU RELAY

(71) Applicant: InterDigital Patent Holdings, Inc., Wilmington, DE (US)

(72) Inventors: Martino FREDA, Laval (CA); Tuong Hoang, Montreal (CA); Oumer Teyeb, Montreal (CA); Jongwoo Hong, New York, NY (US); Ananth Kini, Conshohocken, PA (US); Benoit Pelletier, Roxboro (CA)

(21) Appl. No.: 19/482,638

(22) PCT Filed: May 2, 2024
(86) PCT No.: PCT/US2024/027474

§ 371 Date: Nov. 7, 2025

Related U.S. Application Data
(60) Provisional application No. 63/464,995, filed on May 9, 2023.

(51) Int. Cl. H04W 28/02; H04W 88/04

(52) U.S. Cl. CPC H04W 28/0268; H04W 28/0236; H04W 88/04

(57) ABSTRACT

A method implemented in a relay wireless transmit/receive unit WTRU may include receiving QoS information indicating a QoS profile and receiving bearer information indicating an end-to-end bearer from a source WTRU. The method may include determining a second packet delay budget (PDB) on a second hop for the end-to-end bearer and determining a first PDB on a first hop for the end-to-end bearer based on the second PDB and an end-to-end PDB. The method may include sending PDB information to the source WTRU indicating the first PDB. In a case where a first RLC channel established with a target WTRU corresponds to a second RLC channel configured for the QoS profile, the second PDB on the second hop may be determined to be a PDB associated with the first RLC channel, and the end-to-end bearer may be associated with the first RLC channel.

### CROSS-REFERENCE TO RELATED APPLICATIONS

This application claims the benefit of U.S. Patent Application No. 63/464,995 filed May 9, 2023, which is incorporated herein by reference in its entirety.

### TECHNICAL FIELD

The present disclosure is generally directed to the fields of communications, software and encoding, including methods, architectures, apparatuses, and systems directed to configuration and quality of service (QOS) management for wireless transmit/receive unit (WTRU) to WTRU relays.

### BACKGROUND

New radio (NR) vehicle to everything (V2X) has been introduced in the third-generation partnership project (3GPP) release 16. NR VTX supports configuration procedure for unicast, groupcast, and broadcast. The transmitting (Tx) WTRU may determine the sidelink (SL) bearer configuration from the QoS profile of the QoS flow initiated by the upper layers of the Tx WTRU. Embodiments described herein have been designed with the foregoing in mind.

### BRIEF SUMMARY

Methods, architectures, apparatuses, and systems directed to configuration and QoS management for WTRU-to-WTRU relays are described herein. In an embodiment, a method implemented in a relay WTRU is described herein. The method may include receiving QoS information indicating a QoS profile and receiving bearer information indicating an end-to-end bearer from a source WTRU. The method may include determining a second packet delay budget (PDB) on a second hop for the end-to-end bearer. The method may include determining a first PDB on a first hop for the end-to-end bearer based on the second PDB and an end-to-end PDB. The method may include sending PDB information to the source WTRU indicating the first PDB. In various embodiments, in a case where a first RLC channel established with a target WTRU corresponds to a second RLC channel configured for the QoS profile, the second PDB on the second hop may be determined to be a PDB associated with the first RLC channel, and the end-to-end bearer may be associated with the first RLC channel.

In an embodiment, a WTRU comprising circuitry including any of a processor, a transmitter, a receiver, and a memory is described herein. The circuitry may be configured to carry out the method.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of VTX communication;

FIG. 3 is a diagram illustrating an example of user plane protocol stack for layer 2 WTRU to network relays;

FIG. 4 is a diagram illustrating an example of WTRU to network relay communication;

FIG. 5 is a diagram illustrating an example of architecture for layer 2 WTRU-to-WTRU relay; and

FIG. 6 is a diagram illustrating an example method for determining a PDB split for WTRU-to-WTRU relays.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

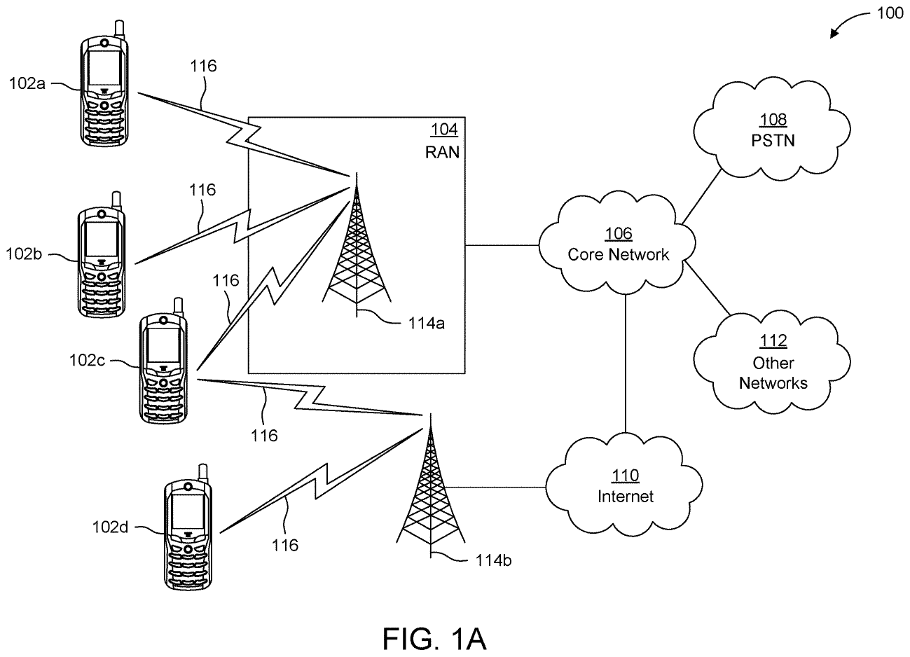

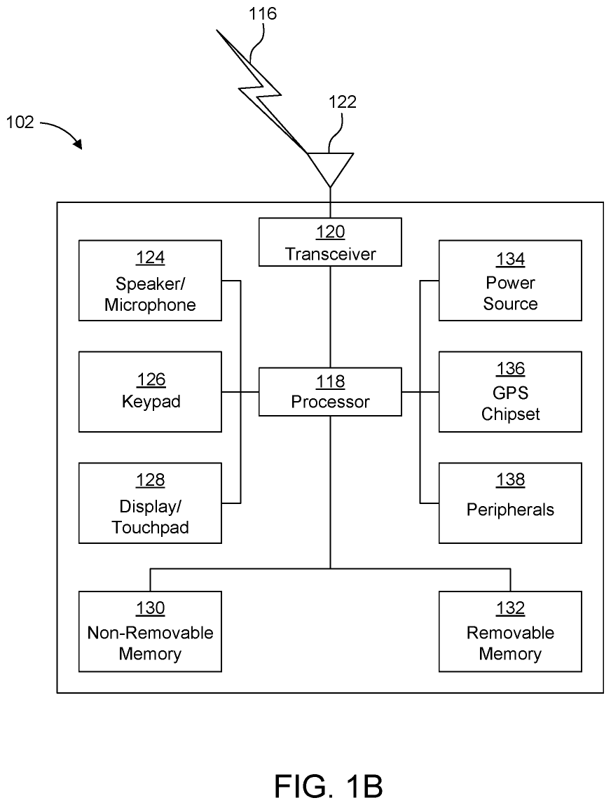

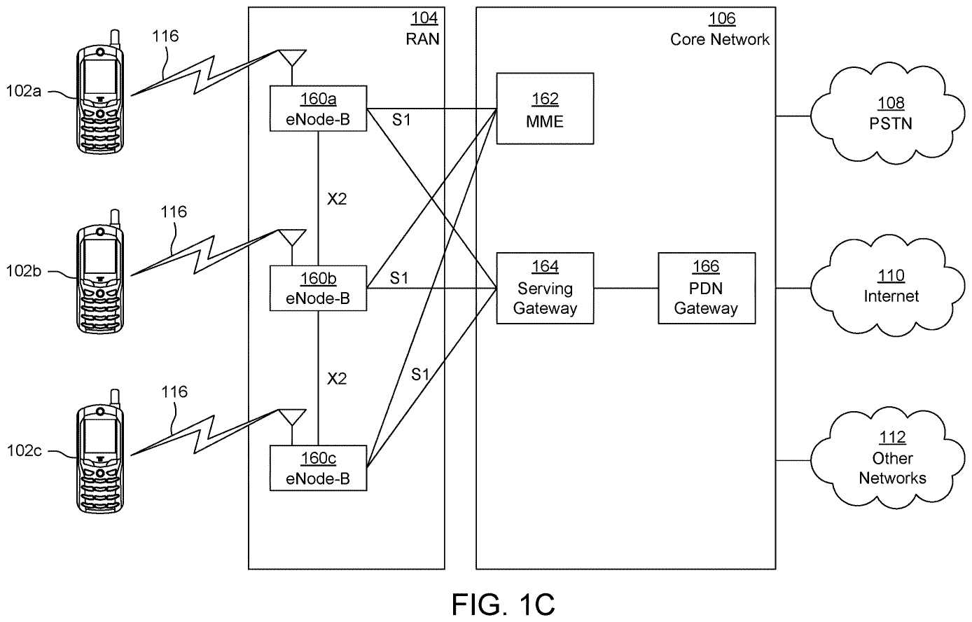

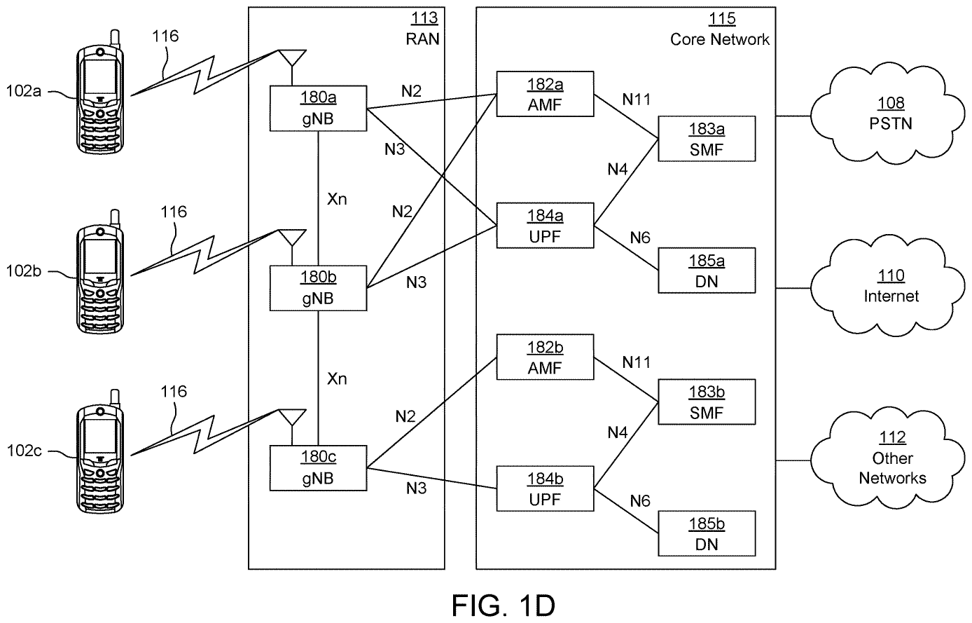

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “a WTRU may be configured with something” may be used interchangeably with “a WTRU may receive configuration information indicating something”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

### Example of RLC Channel Configuration Procedure in VTX

NR V 2X has been introduced 3GPP NR release 16. NR VTX supports configuration procedure for unicast, groupcast, and broadcast. The Tx WTRU may determine the sidelink (SL) bearer configuration (e.g., any of packet data convergence protocol (PDCP), radio link control (RLC), and medium access control (MAC), etc. configuration parameters) from the QoS profile of the QoS flow initiated by the upper layers of the Tx WTRU.

Determination of the bearer configuration may depend on the (e.g., radio resource control (RRC)) state of the Tx WTRU. In a case where the Tx WTRU is in any of idle state (e.g., RRC_IDLE), inactive state (e.g., RRC_INACTIVE) and out of network coverage (OOC), the WTRU may obtain the bearer configuration (e.g., parameters) to use from any of the system information broadcast (SIB) and pre-configuration. Any of the SIB and the pre-configuration may include an (e.g., exhaustive) list of bearer configurations to be used for a (e.g., each) QoS profile. If a QoS profile is not included in any of the SIB and the pre-configuration, the WTRU may use a default bearer configuration and may map (e.g., associate) that QoS flow to the default bearer. A WTRU in a connected state (such as e.g., RRC_CONNECTED) may send information indicating the QoS profile of the QoS flow to the network (in a case where the flow is initiated) and may receive the bearer configuration for the QoS flow from (e.g., dedicated) RRC signaling.

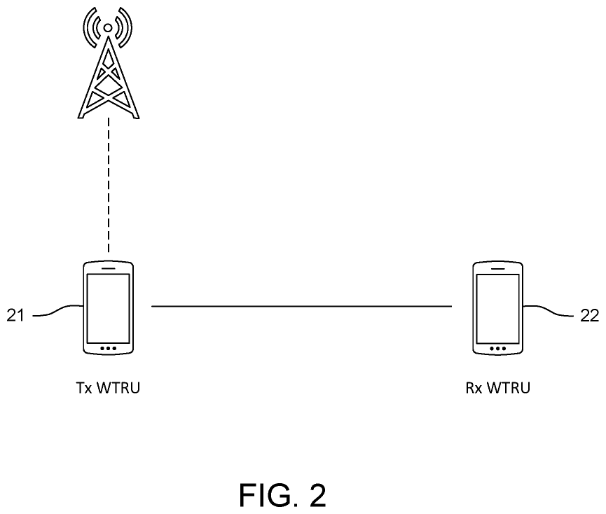

FIG. 2 is a diagram illustrating an example of VTX communication. In a first mode of scheduling (which may be referred to herein as mode 1) the network may manage scheduling (e.g., schedule) the resources to the Tx WTRU 21 such that the latency expectations (e.g., requirements) of (e.g., each) transmission between the Tx WTRU 21 and the Rx WTRU 22 may be met. In a second mode of scheduling (which may be referred to herein as mode 2), the Tx WTRU 21 may perform the scheduling, and the latency management may be built into the resource selection procedure. For example, in a case where data trigger the resource selection procedure, the Tx WTRU 21 may select resources with a resource selection window determined based on the packet delay budget (PDB) of the highest priority data available for transmission. This may allow to meet the latency associated with that data. The network may not be involved in determining the PDB (e.g., in the logical channel), the PDB being known to the Tx WTRU 21 from the QoS profile.

### Example of RLC Channel Configuration Procedure in WTRU to Network Relays

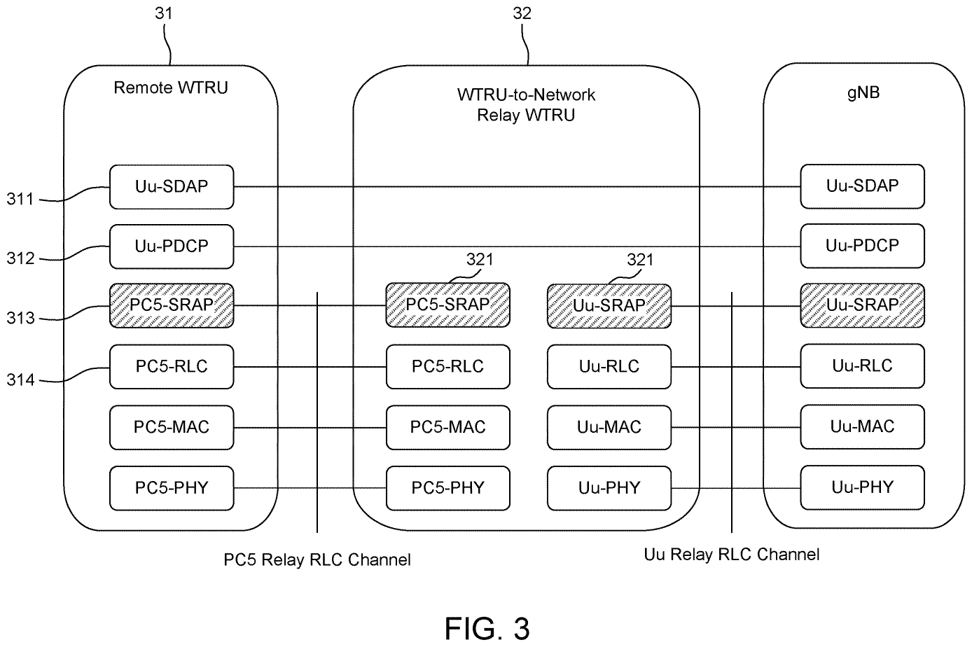

FIG. 3 is a diagram illustrating an example of user plane protocol stack for layer 2 (L2) WTRU to network (NW) relays.

With Uu, the WTRU may receive information indicating a bearer configuration from the network in (e.g., dedicated) RRC signaling. For WTRU-to-NW relays, the network may configure the end-to-end service data adaptation protocol (SDAP) 311 and PDCP 312 to the remote WTRU 31, the sidelink relay adaptation protocol (SRAP) 313 at the remote WTRU 31, the SRAP 321 at the relay WTRU 32, and the RLC 314 and below at the remote WTRU 31. Configuration may be performed by the network using (e.g., dedicated) RRC signaling, e.g., considering that the remote WTRU 31 (apart from communicating to the network via a relay) may be treated as a normal WTRU in Uu. For example, the remote WTRU 31 may receive information indicating its data radio bearer (DRB) configuration using dedicated signaling (such as e.g., a RRCReconfiguration message) received via a relayed signaling radio bearer (SRB).

In WTRU-to-NW relays, the network may configure the adaptation layer (SRAP). The SRAP at the relay WTRU 32 may perform the multiplexing of PC5 RLC channels to Uu RLC channels (in uplink) and vice versa (in downlink). For example, the network may multiplex multiple PC5-RLC channels in uplink to the same Uu RLC channel. Based on the mapping, the adaptation layer may perform the routing upon reception of packets at the relay WTRU.

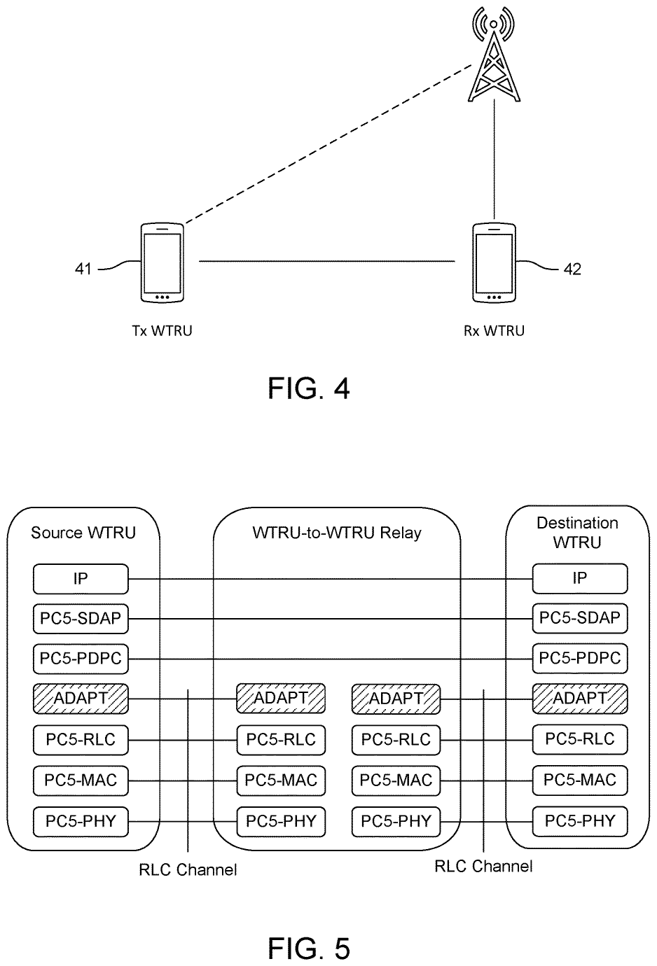

FIG. 4 is a diagram illustrating an example of WTRU-to-NW relay communication. For WTRU-to-NW relays and for the transmission on sidelink, the remote WTRU 41 may operate in mode 2. For uplink transmissions, the latency associated with a remote WTRU's transmissions may comprise a SL part and a Uu part. Considering that the network may control the latency on the Uu part and the WTRU (through resource selection) may control the SL part, a coordination between the network and the WTRU may allow the sum of the latencies to meet the PDB of the packet. For example, the PDB associated with the packet may indicate the end-to-end latency and may not be used for determining the resource selection window (as in V2X). The network may configure the PDB split. For example, the network may provide (e.g., transmit information to) the remote WTRU 41 (e.g., indicating), for a (e.g., each) SL logical channel (LCH) which may be relayed by the relay WTRU 42, a PDB that may be used for the resource selection procedure in mode 2.

### Example of WTRU-to-WTRU Relays

FIG. 5 is a diagram illustrating an example of architecture for L2 WTRU-to-WTRU relay. In WTRU-to-WTRU relays, any of the WTRUs involved (source WTRU, destination WTRU, and relay WTRU) may be in coverage or out of coverage, and may be in any (e.g., RRC) state.

Configuration of the bearers for WTRU-to-WTRU relay may follow the concept of V2X (e.g., configuration by the Tx WTRU). Compared to the non-relayed case, embodiments described herein may allow to address PDB splitting, bearer configuration and adaptation layer configuration.

The end-to-end latency (e.g., requirement) may be split between the two hops. Embodiments described herein may allow to coordinate the PDB splitting between the two transmitting WTRUs (e.g., the source WTRU and the relay WTRU). Embodiments described herein may allow to account for the case where one or both WTRUs may be operating in mode 1, in which case the network may handle the latency on that WTRU's link and may inform the peer.

Bearer configuration may comprise configuring the end-to-end upper layers at the source WTRU, and the RLC channel configuration at the source WTRU and the relay WTRU. Embodiments described herein may allow to address situations where the source WTRU and the relay WTRU may be in different (e.g., RRC) states and/or under the coverage of different gNBs, etc.

At least for the OOC case, the relay WTRU and/or the remote WTRU may configure the adaptation layer mapping. The mapping may ensure that the QoS may be met. Embodiments described herein may allow to provide rules to avoid creating additional RLC channels when QoS flows may be handled with a single RLC channel (on any of the first hop and the second hop).

The adaptation layer may allow to avoid exhausting LCH identifiers (IDs). For example, if a large number of source WTRUs communicate with the same destination WTRU, a one to one mapping (e.g., association) between bearer ID and RLC channel ID on the second hop may result in exhausting the number of LCH IDs on the second hop. This may be avoided by multiplexing bearers with similar QoS on the second hop to the same RLC channel, which may restrict the PDB on the second hop for all of these bearers to having the same configured value.

### Example of Relay WTRU Determining a PDB Split Based on Configuration

In an embodiment, a relay WTRU may determine the PDB split between a first and a second hop based on the existence of an established RLC channel that may meet the QoS indicated by the source WTRU.

The relay WTRU may receive QoS information (e.g., indicating any of a PC5 5G QoS identifier (PQI) and an end-to-end PDB) and (e.g., second information indicating) an end-to-end bearer ID for a new end-to-end bearer from a source WTRU.

The relay WTRU may receive, from the network, (e.g., information indicating) a set of usable second hop RLC channel configurations associated with the (e.g., each) QoS information.

In a case where the relay WTRU has an established RLC channel to the target WTRU which may be equivalent to the RLC channel associated with the received QoS profile, the relay WTRU may determine the PDB on the second hop for the end-to-end bearer to be the PDB associated with the established RLC channel, and the relay WTRU may map (e.g., associate) the end-to-end bearer with the bearer ID to the (e.g., already) established RLC channel. For example, an established RLC channel to the target WTRU may be equivalent to the RLC channel associated with the received QoS profile in a case where the configuration of the established RLC channel corresponds to a configured RLC channel for the QoS profile or for a QoS profile having parameters satisfying a similarity condition (e.g., differing by less than an offset).

Otherwise, (e.g., in a case where the relay WTRU has no established RLC channel to the target WTRU equivalent to the RLC channel associated with the received QoS profile), the relay WTRU may determine a PDB for the second hop based on the measured channel busy ratio (CBR), the WTRU relay may select a configuration for a new RLC channel from the set of usable RLC channel configurations associated with the received QoS (e.g., profile), the WTRU relay may create a new RLC channel with the selected configuration and determined PDB, and the WTRU relay may map (e.g., associate) the end-to-end bearer with the bearer ID with the created RLC channel.

The relay WTRU may determine the PDB on the first hop as the end-to-end PDB minus the determined PDB on second hop and may send PDB information indicating the first hop PDB to the source WTRU.

When receiving a PDU from the source WTRU containing (e.g., information indicating) the end-to-end bearer ID for this end-to-end bearer, the WTRU relay may transmit the packet on the mapped (e.g., associated) RLC channel.

When selecting resources for transmission of the packet, the WTRU relay may select a resource within the determined PDB.

### Terminology

In embodiments described herein, LCH and RLC channel may be used interchangeably, and refer to the RLC channel associated with the lower layers between the source or destination WTRU and the relay WTRU, considering that the relay WTRU may not be configured with any protocol layers above the RLC (apart from the adaptation layer).

Embodiments are described herein based on the (e.g., 3GPP) RLC protocol as an example of layer-2 wireless protocol used on top of a MAC layer. Any other type of layer 2 wireless protocol may be applicable to embodiments described herein.

In embodiments described herein, the adaptation layer refers to the PC5-SRAP when referring to the adaptation layer over sidelink. Embodiments described herein may (e.g., also) be applicable to WTRU-to-NW relays. In that case, the adaptation layer may also refer to the Uu SRAP for embodiments referring to the adaptation layer between the relay WTRU and a network element.

In embodiments described herein, the expressions “mode 1”, “first mode”, “first allocation mode”, and “first mode of scheduling” may be used interchangeably to refer to a mode where the resource allocation may be controlled (e.g., managed) by the network. In embodiments described herein, the expressions “mode 2”, “second mode”, “second allocation mode”, and “second mode of scheduling” may be used interchangeably to refer to a mode where the resource allocation may be controlled (e.g., managed) by the WTRU.

In embodiments described herein, PDU and packet may be used interchangeably.

In embodiments described herein, (unless explicitly differently mentioned) the first hop may refer to the hop between the source WTRU and the relay WTRU, and the second hop may refer to the hop between the relay WTRU and the target WTRU.

In embodiments described herein the terms “split PDB” and “PDB split” may be used interchangeably and may refer to any of (i) the first PDB (e.g., on the first hop), (ii) the second PDB (e.g., on the second hop), and (iii) the first and the second PDBs.

In embodiments described herein, the terms “destination WTRU” and “target WTRU” may be used interchangeably to refer to a remote WTRU that may be reached by a source WTRU via a relay WTRU.

In embodiments described herein, the terms “RLC configuration” and “RLC channel configuration” may be used interchangeably. For the sake of clarity, embodiments are described herein with the example of a RLC configuration as an example of a protocol layer configuration. Embodiments described herein are not limited to RLC configurations, and any kind of (e.g., protocol) layer configuration which may be referred to as first/second configuration may be applicable to embodiments described herein.

### Example of WTRU Determining an Appropriate/Equivalent RLC Channel Configuration

In various embodiments, a WTRU (e.g., any of a relay WTRU and a remote WTRU) may determine an appropriate, equivalent, or allowable RLC channel configuration based on QoS and/or PDB. These terms may be used interchangeably throughout embodiments described herein. For example, a WTRU may determine whether an established RLC channel having a (e.g., given) configuration may be used to perform data transmission for a new QoS flow and/or bearer. For example, a WTRU may determine whether a first RLC configuration may be equivalent to a second RLC configuration. For example, a WTRU may decide (e.g., determine) an RLC configuration to be used for establishing an RLC channel to be used for transmitting data for a QoS flow and/or bearer.

According to any embodiment described herein, the determination of an (e.g., appropriate, equivalent, allowable) RLC channel configuration may be based on any of (i) a lookup table based approach, (ii) a difference in one or more parameters of the RLC channel configuration, (iii) a difference in one or more QoS parameters used to obtain the RLC channel configuration, and (iv) any of the (e.g., current) traffic situation and (e.g., current) channel conditions.

In an example of the lookup table-based approach, a WTRU may determine an (e.g., appropriate) RLC channel configuration for a QoS profile and/or PDB by selecting one of the configured RLC channel configurations (e.g., in any of SIB and pre-configuration) that may be configured for the QoS profile, for the PDB, or for the combination of QoS profile and PDB.

In another example of the lookup table-based approach, a WTRU may select (e.g., an RLC channel configuration) from a subset of RLC configurations that may be associated with the hop it may be allocated to. For example, a WTRU may receive (e.g., information indicating) a set of RLC configurations associated with the second hop and a set of RLC configurations associated with the first hop. A relay WTRU may select (e.g., only) from the subset of configurations associated with relays, and a source WTRU may select (e.g., only) from the subset of configurations associated with a source WTRU.

In yet another example of the lookup table-based approach, a WTRU may select (e.g., an RLC channel configuration) from a subset of RLC configurations that may be associated with any of a determined PDB, a PDB split, a percentage of end-to-end PDB, etc. For example, a (e.g., each) RLC configuration may be associated with any of an allowable PDB and a PDB split, and the WTRU may select from the RLC configurations for any of that PDB and PDB split after any of the PDB and PDB split may have been determined.

In yet another example of the lookup table-based approach, a WTRU may be configured with an RLC channel with a first configuration. The WTRU may determine an (e.g., equivalent or allowable) RLC channel configuration in a case where there exists a second configured RLC channel configuration, which may be different from the first configuration, and which may be associated with the same QoS parameters.

In an example based on the difference in one or more parameters of the RLC channel configuration, a WTRU may determine a second configuration to be equivalent to a first configuration in a case where one or more parameters satisfies a similarity condition (e.g., is different by less than a specific amount), such as, for example any of (i) the difference in priority is below a threshold, (ii) the difference in any of a window size, a sequence number size, etc. is below a threshold, and (iii) the difference in radio link failure (RLF) triggering condition is below a threshold.

In another example based on the difference in one or more parameters of the RLC channel configuration, a WTRU may determine a second configuration to be equivalent to a first configuration in a case where the second configuration results in a QoS that is at least as stringent as (e.g., or more stringent than) the first configuration.

In an example based on the difference in one or more QoS parameters used to obtain the configuration, the WTRU may determine whether a second configuration is equivalent to a first configuration, or if the second configuration is an appropriate configuration, for example, in a case where the WTRU may find (e.g., determine) a (e.g., another) configured RLC channel configuration for the same QoS profile, or for a QoS profile that may be obtained by changing one or more parameters of the original QoS profile, e.g., by an offset. For example, a first RLC channel associated with a first QoS profile may be determined to be equivalent to a second RLC channel associated with a second QoS profile in a case where the first and the second QoS profiles are similar (e.g., a same QoS profile, or having one or more parameters differing by less than an offset). A WTRU may restrict the change in the QoS profile or parameters of the QoS profile such that the parameters may be more stringent (e.g., higher priority, larger bit rate, shorter latency, etc.).

For example, the lookup table-based approach applied to a first QoS profile may lead to a first configuration. The WTRU may determine an equivalent configuration (or an appropriate configuration for the same QoS profile) by changing one or more parameters in the QoS profile by less than a (e.g., configured) offset (for example, making the QoS profile more stringent) and obtaining a second configuration for the new QoS profile from the lookup table-based approach.

In another example based on the difference in one or more QoS parameters used to obtain the configuration, the offset in the allowed QoS parameter may depend on the (e.g., current) routing situation, such as any of the (e.g., current) number of channels, a measure of the (e.g., current) traffic, a measure of the (e.g., current) channel characteristics, etc. For example, if the CBR is above a threshold, the WTRU may not be allowed to use any offset in the QoS parameters at the time. For example, if the average or current amount of traffic buffered (or expected on (e.g., all of) the bearers) is above a threshold, the WTRU may not be allowed to use any offset in the QoS parameters at the time.

In an example based on a (e.g., current) traffic situation and (e.g., current) channel conditions, a WTRU may determine that an existing configuration (e.g., the configuration associated with an existing (e.g., established) RLC channel) may be used for a QoS flow and/or bearer based on any of the (e.g., current) traffic situation and channel conditions. For example, the WTRU may determine whether the WTRU may be allowed to route an additional bearer to an existing (e.g., established) RLC channel based on any or a combination of the following examples.

In a first example, the WTRU may determine whether the WTRU may be allowed to route an additional bearer to an established RLC channel based on a total number of bearers, e.g., with a (e.g., given) QoS profile, mapped to (e.g., associated with) the same RLC channel. For example, if the number of bearers mapped to (e.g., associated with) the same RLC channel at the relay WTRU satisfies a condition (e.g., exceeds a threshold), the relay WTRU may not be allowed to map an additional bearer and/or QoS flow to the same RLC channel and may create a new RLC channel (despite the ability to find an RLC channel configuration that may meet the QoS requirements). For example, if the number of bearers of a (e.g., specific) type (e.g., any of with guaranteed bitrate (GBR), and flagged in the bearer configuration) mapped to (e.g., associated with) the same RLC channel at the relay WTRU satisfies a condition (e.g., exceeds) a threshold, the relay WTRU may not be allowed to map an additional bearer and/or QoS flow to the same RLC channel and may create a new RLC channel (despite the ability to find an RLC channel that may meet the QoS requirements).

In a second example, the WTRU may determine whether the WTRU may be allowed to route an additional bearer to an established RLC channel based on any of channel congestion, and channel occupancy metric. For example, if the CBR is above a threshold, the relay WTRU may not be allowed to map an additional bearer and/or QoS flow to the same RLC channel and may create a new RLC channel (despite the ability to find an RLC channel configuration that may meet the QoS requirements).

In a third example, the WTRU may determine whether the WTRU may be allowed to route an additional bearer to an established RLC channel based on a buffer status. For example, in a case where the buffer status at the relay WTRU, e.g., associated with the RLC channel, is above a threshold, the relay WTRU may not be allowed to map an additional bearer and/or QoS flow to the same RLC channel and may create a new RLC channel (despite the ability to find an RLC channel configuration that may meet the QoS requirements).

In a fourth example, the WTRU may determine whether the WTRU may be allowed to route an additional bearer to an established RLC channel based on expected (e.g., maximum) data rate on the RLC channel based on QoS properties. For example, in a case where the (e.g., maximum total) data rate expected on the RLC channel (e.g., computed based on the sum of the data rates for the QoS flows) exceeds a threshold, the relay WTRU may not be allowed to map an additional bearer and/or QoS flow to the same RLC channel and may create a new RLC channel (despite the ability to find an RLC channel configuration that may meet the QoS requirements).

Thresholds described herein may be determined based on any factors (parameters) described herein.

### Example of Relay WTRU Determining the Adaptation Layer Mapping for an End-to-End Bearer Over the Second Hop

In embodiments described herein, a relay WTRU may determine an adaptation layer mapping in terms of RLC channels or LCHs based on determining the presence of existing (e.g., established) RLC channels with equivalent (e.g., appropriate) RLC configurations. For example, in embodiments described herein, in a case where a relay WTRU determines to map (e.g., associate) a bearer and/or QoS profile to an existing RLC channel based on equivalence, the relay WTRU may determine the adaptation layer mapping based on this determination (e.g., the bearer associated with a (e.g., given) bearer ID may be mapped to (e.g., associated with) the existing (e.g., established) RLC channel). In another example, in a case where the relay WTRU determines to create a new RLC channel for a bearer, the WTRU may map (e.g., all) subsequent PDUs received with the associated bearer ID to the created new RLC channel when routing the PDU on the next (e.g., second) hop.

### Example of Relay WTRU Determining the PDB Split

In an embodiment, a relay WTRU may determine the PDB split between a first and a second hop based on the existence of an established RLC channel that may meet the QoS indicated by the source WTRU.

The relay WTRU may receive QoS information (e.g., indicating any of a PC5 5G QoS identifier (PQI) and an end-to-end PDB) and (e.g., second information indicating) an end-to-end bearer ID for a new end-to-end bearer from a source WTRU.

The relay WTRU may receive, from the network, (e.g., information indicating) a set of usable second hop RLC channel configurations associated with the (e.g., each) QoS information.

In a case where the relay WTRU has an established RLC channel to the target WTRU which may be equivalent to the RLC channel associated with the received QoS profile, the relay WTRU may determine the PDB on the second hop for the end-to-end bearer to be the PDB associated with the established RLC channel, and the relay WTRU may map (e.g., associate) the end-to-end bearer with the bearer ID to the (e.g., already) established RLC channel. For example, an established RLC channel to the target WTRU may be equivalent to the RLC channel associated with the received QoS profile in a case where the configuration of the established RLC channel corresponds to a configured RLC channel for the QoS profile or for a QoS profile having parameters satisfying a similarity condition (e.g., differing by less than an offset).

Otherwise, (e.g., in a case where the relay WTRU has no established RLC channel to the target WTRU equivalent to the RLC channel associated with the received QoS profile), the relay WTRU may determine a PDB for the second hop based on the measured channel busy ratio (CBR), the WTRU relay may select a configuration for a new RLC channel from the set of usable RLC channel configurations associated with the received QoS (e.g., profile), the WTRU relay may create a new RLC channel with the selected configuration and determined PDB, and the WTRU relay may map (e.g., associate) the end-to-end bearer with the bearer ID with the created RLC channel.

The relay WTRU may determine the PDB on the first hop as the end-to-end PDB minus the determined PDB on second hop and may send PDB information indicating the first hop PDB to the source WTRU.

When receiving a PDU from the source WTRU containing (e.g., information indicating) the end-to-end bearer ID for this end-to-end bearer, the WTRU relay may transmit the packet on the mapped (e.g., associated) RLC channel.

When selecting resources for transmission of the packet, the WTRU relay may select a resource within the determined PDB.

The embodiment for determining the PDB split is described herein with the example of a WTRU relay. The embodiment described herein may apply to the source WTRU (e.g., where the source and relay WTRU (and second hop and first hop) may be reversed in the embodiment description).

### Example of Relay WTRU Determining the PDB on the Second Hop and e.g., the First Hop

The relay WTRU may determine the PDB on the second hop. For example, the relay WTRU may (e.g., also) determine the PDB for the first hop and may send information indicating that PDB to the source WTRU. The determination of the PDB(s) may be based on one or more of a signaling (e.g., message received) from the source WTRU, a RRC state, a coverage, a scheduling mode, a cell ID relationship and a RLC channel configuration. Whether the relay WTRU determines the PDB (e.g., also) for the first hop may depend (e.g., be based) on one or more of a signaling (e.g., message received) from the source WTRU, a RRC state, a coverage, a scheduling mode, a cell ID relationship and a RLC channel configuration.

### Example of Relay WTRU Determining the PDB From Measurements

In an embodiment, a relay WTRU may determine any of the PDB or the PDB split based on any of measurements of sidelink, measurements of congestion, and measurements of channel quality indicator (CQI), etc. For example, the relay WTRU may be configured with a PDB split percentage to be used based on the RSRP of the first and/or second link (e.g., hop).

### Example of Relay WTRU Determining the PDB or a Minimum PDB From QoS Information

In an embodiment, a relay WTRU may determine any of the PDB, the PDB split, and a (e.g., minimum) allowable PDB on a (e.g., given) hop based on QoS information. For example, the relay WTRU may determine a (e.g., minimum) PDB based on the bit rate (GBR) of the bearer and/or the QoS flow. For example, the relay WTRU may determine the PDB on the second hop to be at least larger than the minimum for that rate. In another example, the relay WTRU may determine the PDB associated with an RLC channel (for the second hop) to satisfy a condition (e.g., be larger or equal to the minimum of the sum of bit rates (or some relationship associated with the QoS) of all bearers mapped to that RLC channel).

In a case where additional bearers are to be mapped to the RLC channel, the relay may create a new RLC channel with a different PDB for any additional bearers to be added.

In a case where additional bearers are to be mapped to the RLC channel, the relay may change the PDB associated with the RLC channel on the second hop such that the condition (e.g., the minimum) is met. This may involve sending information to the source WTRU indicating a change in the PDB on the first hop.

### Example of Relay WTRU Determining the PDB from a Value Received From the Source WTRU

Embodiments described herein apply to a value of PDB received which may refer to any of the first hop PDB and the second hop PDB. The relay WTRU may receive information indicating the second hop PDB (e.g., directly) from the source WTRU, and any embodiment described herein may apply to this second hop PDB. In another example, the relay WTRU may receive information indicating the first hop PDB from the source WTRU any may derive the second hop PDB (e.g., by subtracting the first hop PDB from the end-to-end PDB (e.g., latency requirement)). The relay WTRU may use the derived second hop PDB (e.g., directly) in embodiments described herein, and/or may apply the embodiments described herein (e.g., directly) to the first hop PDB, considering that the sum of the first and second hop PDB may be at most (may be less than or equal to) the end-to-end PDB.

In an embodiment, the relay WTRU may be provided with a (e.g., end to end) PDB value by the source WTRU over PC5 (e.g., in a PC5-RRC message or similar), and may determine its PDB from that value, for example, in combination with other values or other factors described herein. For example, the relay WTRU may determine the PDB of the second hop to be the value received from the source WTRU, or some other value derived from that value. A WTRU may decide whether to determine its own PDB or not depending on whether it receives information indicating a PDB value from the source WTRU. For example, in a case where the relay WTRU receives information indicating a PDB value, the relay WTRU may use that value. In a case where the relay WTRU does not receive any information indicating a PDB value, the relay WTRU may determine its own PDB value, using other methods.

In an embodiment, the relay WTRU may request a PDB for the second hop from the source WTRU. For example, the relay WTRU may send information indicating a request (e.g., in PC5-RRC) to the source WTRU for the PDB to use in the second hop. The relay WTRU may determine whether (e.g., when) to send such request based on any of (i) a scheduling mode, (ii) a RRC state and/or coverage, (iii) a cell ID relationship between the cell controlling the relay and the cell controlling the source WTRU, and (iv) an RLC channel configuration at the relay WTRU and/or source WTRU.

In a first example, the relay WTRU may determine whether (e.g., when) to send a request for a PDB based on a scheduling mode. For example, in a case where the relay WTRU is configured in mode 2, it may request a PDB for the second hop from the source WTRU, otherwise, it may not request a PDB.

In a second example, the relay WTRU may determine whether (e.g., when) to send a request for a PDB based on RRC state and/or coverage. For example, in a case where the relay WTRU is in any of idle and inactive states (e.g., RRC_IDLE, RRC_INACTIVE), the relay WTRU may request a PDB for the second hop from the source WTRU, otherwise, the relay WTRU may not request a PDB. For example, in a case where the relay WTRU is OOC, the relay WTRU may request a PDB for the second hop from the source WTRU, otherwise, the relay WTRU may not request a PDB.

In a third example, the relay WTRU may determine whether (e.g., when) to send a request for a PDB based on a cell ID relationship between the cell controlling the relay and the cell controlling the source WTRU. For example, the relay WTRU may receive information indicating a knowledge of the cell ID controlling the source WTRU from any of a discovery message and a PC5-RRC message. In a case where the relay WTRU determines that the cell ID is the same, or is in a related set (e.g., where the related set may be configured by the network), the relay WTRU may send a request for the PDB on the second hop to the source WTRU.

In a fourth example, the relay WTRU may determine whether (e.g., when) to send a request for a PDB based on an RLC channel configuration at the relay WTRU and/or source WTRU. For example, in a case where the relay WTRU has an existing (e.g., established) RLC channel configured with the same or similar configuration, and for which the destination matches the destination requested by the source WTRU, the relay WTRU may use the PDB of the existing (e.g., established) RLC channel as the PDB to be used. In another example, in a case where the relay WTRU can determine an equivalent (e.g., appropriate) RLC configuration, as described herein, and for which the destination matches the destination requested by the source WTRU, the relay WTRU may use the PDB of the existing (e.g., established) RLC channel as the PDB to be used.

In an embodiment, the relay WTRU may receive information indicating a restriction on the PDB from the source WTRU. For example, the relay WTRU may select a value for the PDB on the second hop that may meet the restriction received from the source WTRU. The relay WTRU may be configured to select a PDB that may meet the restriction received from the source WTRU under some conditions, for example, associated with any of the following examples.

In a first example, a condition may be associated with measurements of the sidelink channel, for example, to the destination. For example, if the RSRP of the link to the destination is below a threshold, the relay WTRU may be allowed to select a PDB that may not meet the restriction received from the source WTRU. In another example, if the CBR is above a threshold, the relay WTRU may be allowed to select a PDB that may not meet the restriction received from the source WTRU.

In a second example, a condition may be associated with a number of and/or presence of other SL logical channels to the destination WTRU, for example, with the same (or similar) configuration. For example, if the relay has a configured RLC channel having the same (or similar) configuration as what may be expected for the source WTRU, the relay WTRU may use a PDB that may not meet the restrictions received from the source WTRU.

In a third example, a condition may be associated with a network indication, for example, for a relay WTRU in coverage and/or in connected state (e.g., RRC_CONNECTED). For example, if the relay WTRU is in connected state (e.g., RRC_CONNECTED) and receives information indicating a PDB from the network, the relay WTRU may use a PDB that may not meet the restriction received from the source WTRU.

In an embodiment, the relay WTRU may be configured with any of a PDB difference and a PDB offset or may receive information indicating any of the PDB difference and PDB offset from the source WTRU. The relay WTRU may determine a PDB that may be equal to the PDB received from the source WTRU, or which may be within the offset of the PDB received from the source WTRU. For example, the source WTRU may provide a first (e.g., desired) PDB. The relay WTRU may determine an offset for which the PDB it may determine may exceed the provided first PDB. For example, the relay WTRU may use any value of PDB which may be less than or equal to the value received from the source WTRU. The relay WTRU may determine to use a value larger than the value received from the source WTRU, in a case where the value is within an offset of the value received from the source WTRU. The relay WTRU may receive information indicating such offset from any of the source WTRU and the network (e.g., in RRC configuration). The relay WTRU may derive such offset from information received from any of the source WTRU and the network. For example, the relay WTRU may derive an offset from the QoS information received from the source WTRU. For example, the relay WTRU may be configured with an offset for a (e.g., each) PQI and may determine the offset from the PQI associated with the LCH being configured.

In embodiments described herein, the relay WTRU may provide (e.g., transmit information indicating) the (e.g., actual) PDB selected for the second hop to the source WTRU. In one example, the relay WTRU may provide it in a case where the source WTRU has not provided one to the relay WTRU. For example, the source WTRU may have provided information indicating a restriction and no information indicating a PDB). In another example, the relay WTRU may provide (e.g., transmit information indicating) the PDB in a case where the relay WTRU determines a different PDB compared to what it may have received from the source WTRU, or in a case where the relay WTRU determines to not follow a restriction received from the source WTRU.

### Example of Relay WTRU Determining the PDB based on Existing and Established RLC Channel Configurations

In an embodiment, a relay WTRU may determine the PDB based on the PDB of existing (e.g., established) RLC channels and depending on whether the QoS flow and/or/bearer initiated may be mapped to (e.g., associated with) the existing (e.g., established) RLC channel. For example, a relay WTRU may receive QoS information from the source WTRU for a (e.g., potential) new bearer to be configured and/or initiated. The relay WTRU may determine whether one of the established RLC channels to the same destination WTRU may be used for the bearer. The relay WTRU may determine whether the RLC configuration of the established RLC channel may be an allowable configuration for the bearer (e.g., an equivalent configuration for the bearer). Any mechanism described herein for determining allowable (e.g., equivalent) configurations may be used. In a case where the established RLC channel has an allowable (e.g., equivalent) configuration, the relay WTRU may determine to map (e.g., associate) the bearer to the established RLC channel. In this instance, the relay WTRU may determine the PDB split based on the (e.g., current) RLC channel. For example, for the new bearer, the second hop PDB of the established RLC channel may be used. If this is not the case, the relay WTRU may determine the PDB split based on other criteria described herein (e.g., any of CBR, RSRP, etc.). The relay WTRU may provide the source WTRU with (e.g., transmit information indicating) the determined PDB split.

### Example of Relay WTRU Determining When to Multiplex Multiple Bearers on the Same RLC Channel

In an embodiment, based on one or more criteria, a relay WTRU may determine to multiplex multiple bearers on the same RLC channel and to use any criteria described herein for determining when to re-use an existing (e.g., established) RLC channel and when to create a new RLC channel.

For example, in a case where the number of RLC channels established at the relay WTRU, for a (e.g., particular) destination WTRU, reaches a threshold, or a threshold percentage of the (e.g., maximum) number of logical channels, the relay WTRU may initiate check for multiplexing. Otherwise, the relay may (e.g., always) perform one to one bearer to RLC channel mapping.

For example, in a case where the CBR is below a threshold, the relay WTRU may initiate check for multiplexing. Otherwise, the relay may (e.g., always) perform one to one bearer to RLC channel mapping.

For example, in a case where the bearer has (e.g., specific) QoS characteristics (e.g., any of a PQI, a priority, etc.), the relay WTRU may initiate check for multiplexing. Otherwise, the relay may (e.g., always) perform one to one bearer to RLC channel mapping.

### Example of Relay WTRU Reporting the Second Hop and/or the First Hop PDB to the Network

The relay WTRU may report (e.g., transmit information indicating) the second hop PDB and/or the first hop PDB to the network e.g., for the purpose of being configured with any missing PDB and/or of reporting to the network the PDB to be used on the other hop (e.g., in a case where one hop is configured in mode 1).

In an embodiment, the relay WTRU may report (e.g., transmit information indicating) the first hop PDB and/or the second hop PDB received from the source WTRU to the network. The relay WTRU may report the PDB based on any of the following examples of conditions.

In a first example, the relay WTRU may report the PDB to the network in a case where the relay WTRU is configured in mode 1.

In a second example, the relay WTRU may report the PDB to the network in a case where the source WTRU is configured in mode 1, and in a case where the source WTRU indicates being configured in mode 1 (implicitly or explicitly) to the relay WTRU.

In a third example, the relay WTRU may report the PDB to the network in a case where the source WTRU provides (e.g., transmits information indicating) the first hop PDB and/or the second hop PDB. For example, if the source WTRU provides the first hop PDB and the second hop PDB, the relay WTRU may report (e.g., only) the second hop PDB to the network. For example, if the source WTRU provides the first hop PDB (e.g., only), the relay WTRU may report the first hop PDB to the network. For example, if the source WTRU provides the second hop PDB (e.g., only), the relay WTRU may report the second hop PDB to the network.

### Example of How a Relay WTRU may Determine the Second Hop PDB When the NW is Involved

A relay WTRU may determine how to obtain the second hop PDB based on any of an indication from the source WTRU and the allocation mode of the relay WTRU. Similarly, a relay WTRU may determine whether (e.g., how) to determine a first hop PDB and send it back to the source WTRU based on any of an indication from the source WTRU and the allocation mode of the relay WTRU.

In a first example, the indication from the source WTRU may be any of in the form of a mode indication, a reception of the PDB, and an explicit indication. This may be in the form of the relay WTRU receiving any of the first hop PDB and the second hop PDB. For example, in a case where the relay WTRU receives information indicating the first hop PDB and the second hop PDB, the relay WTRU may use the PDB obtained by the source WTRU (or some derived value according to any embodiment described herein) as the second hop PDB. In another example, in a case where the relay WTRU receives information indicating (e.g., only) the first hop PDB, the relay WTRU may obtain the second hop PDB from the network, by providing (e.g., transmitting information indicating) the first hop PDB to the network, and e.g., sending information indicating an updated first hop/second hop PDB to the source WTRU after network configuration. In another example, in a case where the relay WTRU does not receive information indicating the first hop PDB and the second hop PDB, the relay WTRU may obtain the first hop PDB and second hop PDB from the network and may provide (e.g., transmit information indicating) the first hop PDB to the source WTRU.

In a second example, the relay WTRU may determine how to obtain the second hop PDB and/or may determine whether (e.g., how) to determine a first hop PDB and send it back to the source WTRU based on the allocation mode of the relay WTRU. For example, in a case where the relay WTRU is in mode 1, the relay WTRU may ignore the second hop PDB received from the source WTRU. For example, in a case where the relay WTRU is in mode 1, the relay WTRU may report (e.g., transmit information indicating) the first hop PDB and/or the second hop PDB to the network, and e.g., may obtain the first hop PDB to be sent to the source WTRU from the network. For example, in a case where the relay WTRU is in mode 2, the relay WTRU may use the second hop PDB obtained from the source WTRU or may determine its own second hop PDB (e.g., in a case where none was received from the source WTRU). For example, in a case where the relay WTRU is in mode 2, the relay WTRU may send information indicating the first hop PDB (or second hop PDB) it may have determined to the source WTRU.

### Examples of Network Involved PDB Configuration

In an embodiment, a source WTRU may be in mode 1 and a relay WTRU may be in mode 1. The relay WTRU may receive information indicating a first hop PDB and a second hop PDB. The relay WTRU may report (e.g., transmit information indicating) the second hop PDB to the network. In a case where the relay WTRU receives information indicating a new value for the second hop PDB from the network, the relay WTRU may send information indicating the first hop PDB and/or the second hop PDB to the source WTRU.

In an embodiment, a source WTRU may be in mode 1 and a relay WTRU may be in mode 2. In a first example, the relay WTRU may receive information indicating a first hop PDB and a second hop PDB. The relay WTRU may use the second hop PDB obtained from the source WTRU as the PDB for resource selection in mode 2. In a second example, the relay WTRU may receive information indicating a first hop PDB (e.g., only). The relay WTRU may derive the second hop PDB from this first hop PDB. In a case where the relay WTRU determines a condition to change the first hop PDB (as described herein), the relay WTRU may send the new first hop PDB to the source WTRU.

In an embodiment, a source WTRU may be in mode 2 and a relay WTRU may be in mode 1. The relay WTRU may not receive any information indicating a first hop PDB and a second hop PDB. The relay WTRU may report none of these, and, for example, may report (e.g., only) the QoS profile, to the network and may receive information indicating the PDB for the first hop from the network. The relay WTRU may report (e.g., transmit information indicating) the first hop PDB to the source WTRU.

In an embodiment, a source WTRU may be in mode 2 and the relay WTRU may be in mode 2. The relay WTRU may not receive any information indicating a first hop PDB and a second hop PDB. The relay WTRU may determine, on its own (for example, using any methods described herein), the first hop and second hop PDB, and may send information indicating the derived first hop PDB to the source WTRU.

In an embodiment, the relay WTRU may determine whether to (e.g., always) use the provided first hop and/or second hop PDB or to determine whether an alternate PDB may be determined (e.g., by determining whether an existing LCH on the second hop may meet the QoS criteria) based on an additional indication received from the source WTRU along with the PDB. For example, in a case where the indication is received, the second hop PDB may be used as is from the source WTRU without modification (e.g., case where the source WTRU is in mode 1). In a case where no indication is received, the second hop PDB may be changed by the relay WTRU (e.g., if any condition described herein are satisfied) and the relay WTRU may send information indicating the updated PDB to the source WTRU.

In an embodiment, the relay WTRU may provide the same indication to the network when reporting (e.g., transmitting information indicating) the received PDB. Reporting such indication to the network may allow the network to be aware of whether the value received from the source WTRU may be a value which may have been configured by the gNB of the source WTRU, or a value derived from the source WTRU itself (as a (e.g., desired) value, for example).

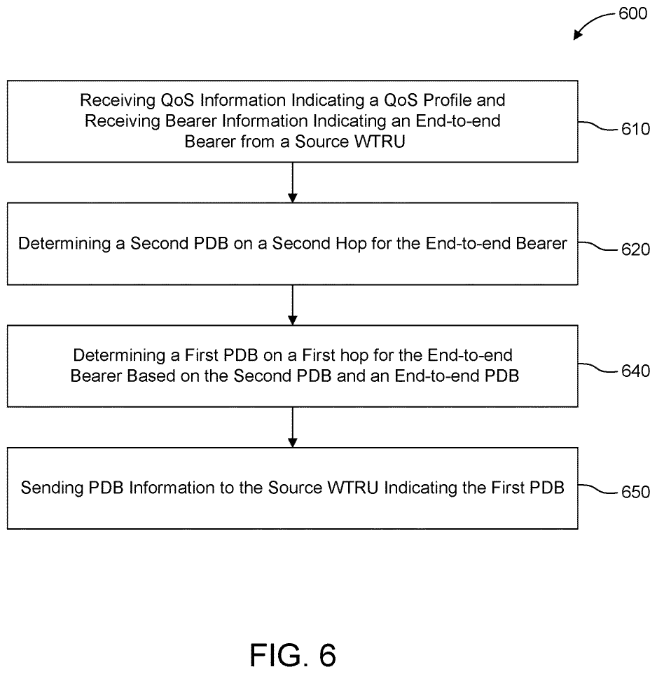

FIG. 6 is a diagram illustrating an example method 600 for determining a PDB split for WTRU-to-WTRU relays. The method 600 may be implemented in a relay WTRU. As shown at 610, the relay WTRU may receive QoS information indicating a QoS profile and may receive bearer information indicating an end-to-end bearer from a source WTRU. As shown at 620, the relay WTRU may determine a second PDB on a second hop for the end-to-end bearer. As shown at 640, the relay WTRU may determine a first PDB on a first hop for the end-to-end bearer based on the second PDB and an end-to-end PDB. As shown at 650, the relay WTRU may send PDB information to the source WTRU indicating the first PDB. In a case where a first RLC channel established with a target WTRU corresponds to a second RLC channel configured for the QoS profile, determining the second PDB on the second hop may comprise determining the second PDB to be a PDB associated with the first RLC channel, and the relay WTRU may associate the end-to-end bearer with the first RLC channel.

In various embodiments, the relay WTRU may receive a packet from the source WTRU for the end-to-end bearer and may transmit the packet on the first RLC channel.

In various embodiments, the relay WTRU may select a resource within the determined second PDB for transmitting the packet on the first RLC channel.

In various embodiments, the relay WTRU may receive configuration information indicating a set of RLC channel configurations associated with the QoS profile.

In various embodiments, in a case where there is no RLC channel established with the target WTRU corresponding to the second RLC channel configured for the QoS profile, determining the second PDB on the second hop may comprise determining the second PDB based on measuring a channel busy ratio.

In various embodiments, in a case where there is no RLC channel established with the target WTRU corresponding to the second RLC channel configured for the QoS profile, the relay WTRU may select a configuration for a new RLC channel from the set of RLC channel configurations associated with the QoS profile.

In various embodiments, in a case where there is no RLC channel established with the target WTRU corresponding to the second RLC channel configured for the QoS profile, the relay WTRU may create a new RLC channel with the selected configuration based on the second PDB.

In various embodiments, the relay WTRU may associate the end-to-end bearer with the new RLC channel.

In various embodiments, the relay WTRU may receive a packet from the source WTRU for the end-to-end bearer and may transmit the packet on the new RLC channel.

In various embodiments, the relay WTRU may select a resource within the second PDB for transmitting the packet on the new RLC channel.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, a processor and a memory configured to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method implemented in a relay wireless transmit/receive unit (WTRU), the method comprising:
receiving quality of service (QoS) information indicating a QoS profile;
receiving bearer information indicating an end-to-end bearer from a source WTRU; and
determining a second packet delay budget (PDB) on a second hop for the end-to-end bearer;
determining a first PDB on a first hop for the end-to-end bearer based on the second PDB and an end-to-end PDB; and
sending PDB information to the source WTRU indicating the first PDB;
wherein in a case where a first radio link control (RLC) channel established with a target WTRU corresponds to a second RLC channel configured for the QoS profile, determining the second PDB on the second hop comprises determining the second PDB to be a PDB associated with the first RLC channel, and wherein the method further comprises associating the end-to-end bearer with the first RLC channel.

2. The method of claim 1, further comprising receiving a packet from the source WTRU for the end-to-end bearer and transmitting the packet on the first RLC channel.

3. The method of claim 2, further comprising selecting a resource within the second PDB for transmitting the packet on the first RLC channel.

4. The method of claim 1, to further comprising receiving configuration information indicating a set of RLC channel configurations associated with the QoS profile.

5. The method of claim 1, wherein in a case where there is no RLC channel established with the target WTRU corresponding to the second RLC channel configured for the QoS profile, determining the second PDB on the second hop comprises determining the second PDB based on measuring a channel busy ratio.

6. The method of claim 4, wherein in a case where there is no RLC channel established with the target WTRU corresponding to the second RLC channel configured for the QoS profile, the method further comprises selecting a configuration for a new RLC channel from the set of RLC channel configurations associated with the QoS profile.

7. The method of claim 6, wherein in a case where there is no RLC channel established with the target WTRU corresponding to the second RLC channel configured for the QoS profile, the method further comprises creating the new RLC channel with the selected configuration based on the second PDB.

8. The method of claim 7, further comprising associating the end-to-end bearer with the new RLC channel.

9. The method of claim 7, further comprising receiving a packet from the source WTRU for the end-to-end bearer, and transmitting the packet on the new RLC channel.

10. The method of claim 9, further comprising selecting a resource within the second PDB for transmitting the packet on the new RLC channel.

11. A wireless transmit/receive unit (WTRU) comprising circuitry, including a transmitter, a receiver, a processor, and a memory, configured to:
receive quality of service (QoS) information indicating a QoS profile;
receive bearer information indicating an end-to-end bearer from a source WTRU;
determine a second packet delay budget (PDB) on a second hop for the end-to-end bearer;
determine a first PDB on a first hop for the end-to-end bearer based on the second PDB and an end-to-end PDB; and
send PDB information to the source WTRU indicating the first PDB;
wherein in a case where a first radio link control (RLC) channel established with a target WTRU corresponds to a second RLC channel configured for the QoS profile, being configured to determine the second PDB on the second hop comprises being configured to determine the second PDB to be a PDB associated with the first RLC channel, and wherein the WTRU is further configured to associate the end-to-end bearer with the first RLC channel.

12. The WTRU of claim 11, further configured to receive a packet from the source WTRU for the end-to-end bearer and transmit the packet on the first RLC channel.

13. The WTRU of claim 12, further configured to select a resource within the second PDB for transmitting the packet on the first RLC channel.

14. The WTRU of claim 11, further configured to receive configuration information indicating a set of RLC channel configurations associated with the QoS profile.

15. The WTRU of claim 11, wherein in a case where there is no RLC channel established with the target WTRU corresponding to the second RLC channel configured for the QoS profile, being configured to determine the second PDB on the second hop comprises being configured to determine the second PDB based on measuring a channel busy ratio.

16. The WTRU of any of claim 14, wherein in a case where there is no RLC channel established with the target WTRU corresponding to the second RLC channel configured for the QoS profile, the WTRU is further configured to select a configuration for a new RLC channel from the set of RLC channel configurations associated with the QoS profile.

17. The WTRU of claim 16, wherein in a case where there is no RLC channel established with the target WTRU corresponding to the second RLC channel configured for the QoS profile, the WTRU is further configured to create the new RLC channel with the selected configuration based on the second PDB.

18. The WTRU of claim 17, further configured to associate the end-to-end bearer with the new RLC channel.

19. The WTRU of claim 17, further configured to receive a packet from the source WTRU for the end-to-end bearer and transmit the packet on the new RLC channel.

20. The WTRU of claim 19, further configured to select a resource within the second PDB for transmitting the packet on the new RLC channel.
